(19) United States
(12) Patent Application Publication
(10) Pub. No.: US 2011/0082748 A1
(43) Pub. Date: Apr. 7, 2011

(54) BRAND LEVERAGED LOCATION BASED SERVICE

(76) Inventor: Alexander Manu, Toronto (CA)

(21) Appl. No.: 12/894,211

(22) Filed: Sep. 30, 2010

Related U.S. Application Data
(60) Provisional application No. 61/247,727, filed on Oct. 1, 2009.

(51) Int. Cl. G06Q 30/00

(52) U.S. Cl. 705/14.58

(57) ABSTRACT

This specification describes a process comprising the steps of (a) determining attributes of products or services that would be desirable to a user considering that user's indication of trust in a brand, (b) determining the location of the user, (c) locating goods or services having the attributes and available for sale in proximity of the user and (d) advising the users of those goods and services.

This application claims the benefit of U.S. Provisional Application No. 61/247,727 filed Oct. 1, 2009, the entire contents of which are incorporated herein by this reference to it.

### FIELD

This invention relates to the field of location based services.

### BACKGROUND

Consumers use brands for convenience and the quality of the experience: the convenience is that you know what you are getting as a result and the experience generates satisfaction. Presently brands monetize the trust users have in them by selling products or services. The trust is a measure by which users feel that the brand owner is delivering on its brand value statement.

A brand value statement has definable attributes in the context of the brand owner's products. These attributes may include, for example, a preference to purchase products within a certain range of market prices, a preference to have warranties or services bundled with products or not, or a preference for natural materials or organic products vs. man made materials.

### INTRODUCTION

Of the hundreds of brands that users purchase, only a few have a high emotional value which translates into trust. A consumer that trusts one brand is likely to seek the attributes of the trusted brand in other brands, products and services. The present concept relates to an apparatus and method that will assist a user in identifying which products and services from their immediate surroundings have attributes that are shared or compatible with the attributes of a brand that is trusted by the user. From the perspective of the owner of a trusted brand, the apparatus and method leverages trust in a brand to enhance brand value by generating revenue, by providing consumers with new satisfying experiences linked to the brand, or both.

The apparatus comprises software that runs on a portable electronic device. For example, the software may be downloaded from a brand owner's web site or in the form of an application that can be downloaded from an application store available to users of a particular personal electronic device that is enabled to send and receive data such as an iPhone or BlackBerry. The apparatus may also comprise additional software running on a computer maintained by the brand owner or a service provider to the brand owner. Additional optional apparatus elements include a pre-existing communications network, a pre-existing GPS system and a pre-existing database of goods and services listed by location and optionally by other attributes.

The method comprises an initial step of determining the attributes of products or services that would be desirable to a user considering that user's past or present indication of trust in a brand. While in active use, the method includes steps of determining the location of the user, locating goods or services having the desired attributes and available for sale in proximity of the user and advising the user of those goods and services. The process may further comprise a step of transmitting an indication of a purchase or possible purchase by the user of a located good or service to the trusted brand owner or to the provider of the located good or service or both. This last step facilitates an agreement whereby the trusted brand owner receives revenue from the owners of located goods and services.

Of all free applications in an application store or available through web sites, a consumer is more likely to install an application linked to a trusted brand than just any other application. Once installed, the application helps the user find desirable proximally located services and products. The application may help to sell products or services of the trusted brand, but also indirectly strengthens the brand by providing a service to consumers of the brand, or by generating revenue.

### DRAWINGS

FIG. 1 is a schematic representation of a method for locating proximal goods and services having the attributes of a trusted brand.

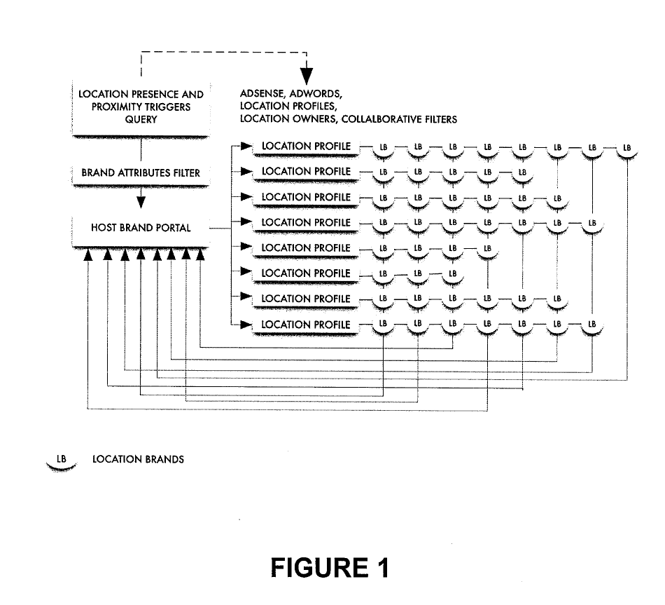

### DESCRIPTION OF VARIOUS EMBODIMENTS

To facilitate a search service considering the user's location and preference for brand related attributes, the owner of a trusted brand creates an application or portal (software program) that can be run on one or more portable electronic devices. The device is an enabled device, enabled to send and receive data, such as an iPhone or a BlackBerry. The brand owner makes the application available to consumers to install on their devices. For example, the application can be made available for download from the brand owner's web site or an application store operated by the company that sells the devices. The application is advertised to the user in association with the trusted brand. In this way, the user's act of downloading the application is an indication of their trust in a brand and the attributes that are desirable to the user. Alternatively or additionally, a user downloading of a brand tagged or even generic application can be asked question during a process of registering for the service or otherwise asked to input information than can be linked to preferred attributes. The input information can be in the form of one or more brands that are trusted by the user.

The application includes, or is able to access through an existing communications network, a database of available goods and services. The database includes information on the location of the goods and services. When prompted by the user or at selected times (for example at regular intervals or at times determined by a polling algorithm) the application locates from within the database those goods and services with a selected proximity to the user. The location of the user is determined, for example, by the application accessing existing GPS capability of the user's device to receive a GPS co-ordinate, or by the user inputting a location. The database of goods and services may be custom made for use by the application or an existing database purchased from others. Existing databases that might be used either in a search or as the basis for creating a filtered database include databases within NAVTEQ Location Profiles and Google Maps.

The goods and services are filtered and then present to the user as a display, for example as a list on or a map on the screen of the portable device, indicating the proximal goods and services likely to be desirable to the user considering the user's known preference for the attributes of the trusted brand. The filtering may have been done in creating the database accessed by the application on the device in which case all proximally located goods and services found in the filtered database are presented to the user. In this case, the pre-filtered database is either maintained by the brand owner for access through a communications network by users, or updated databases may be provided for download to the user's device from time to time.

Alternately, the filtering may be done by the application after or while the application determines a set of all goods and services in the proximity of the user. In this case, the application includes or obtains a file listing the desirable attributes creating considering the user's trust in the brand linked to the application (the “host” brand). The attributes in the file are written in terms of parameters used in a location profile or location brand profile attached to locations in the database. The filter thereby tells the user only the locations and/or identity of goods or services or their providers (the “location brands”) that have the attributes selected considering the host brand. The filter may also consider one or more of other preferences input by the specific user into the application, immediate desires indicated by the user, and collaborative feedback, such as information that other people that have the same application have previously purchased a particular good or service or information that the user has previously purchased goods or services having certain attributes.

The owner of the trusted brand hosting the application may receive value simply from supplying user customers with a useful application that the user associates with the brand. The brand owner may also generate revenue through a agreement with the owner of a location brands. A payment is made under the agreement when there is an indication that the user has, or might have, purchased a product or service associated with a location brand. The indication may comprise one or more or (a) a click through, wherein the user accesses further information about a location or location brand through the application, (b) a walk in, wherein the user within a pre-determined time appears at a location that was presented to the user by the application, and (c) purchase of a product or service associated with a location brand. A walk in may be verified by way of the application accessing a GPS capability on the enabled device periodically over the pre-determined time. A purchase may be verified, for example, by giving the user a location brand discount code. The user gives the discount code to the location brand retailer to receive a discount on the price of the good or service. The retailer transmits the information regarding the sale including the discount code to the owner of the host brand or location brand or both to indicate a payment due under their agreement.

Operating in an automatic mode, the application can periodically obtain a GPS location for the user and make a query automatically. Optionally, the query may be made automatically when a periodic automated GPS polling indicates that the user has moved by a selected distance or entered into a defined space. For example, upon entering a defined space, such as a mall or a shopping district around the intersection at Bloor St. and Yonge St. in Toronto, the user's device makes in a search query that asks, in effect: “what around here is something that a person who appreciates the brand that I trust can get?”. The user receives a message with location details for recommended products and services.

I claim:

1. A process comprising the steps of (a) determining attributes of products or services that would be desirable to a user considering that user's indication of trust in a brand, (b) determining the location of the user, (c) locating goods or services having the attributes and available for sale in proximity of the user and (d) advising the users of those goods and services.

2. The process of claim 1 further comprising a step of transmitting indications of purchase or possible purchase by the user of a located good or service.
